(19) United States
(12) Patent Application Publication
(10) Pub. No.: US 2026/0171640 A1
(43) Pub. Date: Jun. 18, 2026

(54) Filter For Communication Device

(71) Applicant: KMW INC., Hwaseong-si (KR)

(72) Inventors: Nam-shin PARK, Hwaseong-si (KR); Young Jin JUNG, Hwaseong-si (KR); Dong Hyun KIM, Siheung-si (KR)

(73) Assignee: KMW INC., Hwaseong-si (KR)

(21) Appl. No.: 19/534,784

(22) Filed: Feb. 10, 2026

Related U.S. Application Data
(63) Continuation of application No. PCT/KR2024/010646, filed on Jul. 23, 2024.

(30) Foreign Application Priority Data
Aug. 11, 2023 (KR) 10-2023-0105533

(51) Int. Cl. H01P 1/208; H01P 3/12

(52) U.S. Cl. CPC H01P 1/208; H01P 3/12

(57) ABSTRACT

Disclosed is a filter for a communication device. According to an embodiment of the present disclosure, provided is a filter for a communication device, comprising: a housing including a cavity for frequency filtering; and at least one connector that inputs an electrical signal to the cavity or outputs the electrical signal input to the cavity to the outside of the cavity and that is disposed integrally with the filter housing, wherein the filter housing is formed by folding at least a portion of a main plate composed of a conductive plate.

### CROSS-REFERENCE TO RELATED APPLICATION

This application is a continuation application of International Application No. PCT/KR2024/010646, filed Jul. 23, 2024, which claims the benefit of Korean Patent Application No. 10-2024-010646, filed Jul. 23, 2024 in the Korean Intellectual Property Office, the disclosures of which are incorporated herein in their entirety by reference.

### TECHNICAL FIELD

The present disclosure relates to a filter for communication devices.

### BACKGROUND ART

The content described in this section merely provides background information for the present disclosure and does not constitute prior art.

A filter for a communication device, such as a radio frequency filter, may be used for selective filtering of a specific frequency band. The filter for a communication device may be configured as a connection structure of a plurality of resonators.

A resonator is a circuit device that resonates at a specific frequency. The resonator may be configured using a combination of an inductor and a capacitor as an equivalent electronic circuit. The resonator may be installed inside a cavity having a cylindrical shape or a rectangular parallelepiped shape. The resonator may be installed as a dielectric resonance element (DR) or a metal resonance device. The resonator may induce resonance by allowing only an electromagnetic field of an intrinsic frequency in an interested frequency band to exist inside the cavity.

A conventional filter for a communication device is configured to form a plurality of resonant sections using a plurality of cavities, and is configured as a multi-stage structure in which the plurality of resonant sections is sequentially connected. Since such a filter for a communication device forms a multi-stage structure using a plurality of resonant sections, there is a problem in that a volume thereof is large. In addition, such a filter for a communication device has a problem in that weight thereof is increased, since an additional configuration required for forming inductive coupling or capacitive coupling has to be installed inside the cavity in order to enhance skirt characteristics between the plurality of resonators.

A conventional filter for a communication device couples an output connector and a filter housing using bolting. When the connector and the filter housing are bolted to each other, there is a problem in that irregular contact occurs between the connector and the filter housing. The irregular contact between the connector and the filter housing may cause damage to the filter housing and may cause insertion loss.

Meanwhile, in an antenna apparatus to which Massive MIMO (Multiple Input Multiple Output) technology is applied, research is being conducted in a direction of minimizing thickness of internal components such as filters in order to manufacture an overall slim product. Filters mainly used therefor include an MBF (Micro Bellows Filter) and a CWF (Ceramic Waveguide Filter).

However, in a conventional filter, PCBs (printed circuit boards) have to be seated on upper and lower sides of the filter with the filter interposed there between, and thus the filter has to withstand weight thereof, which causes a problem in that the filter itself has to be provided with a thickness and a size capable of bearing the weight. In addition, since a size of the filter is large, there is a problem in that it is not easy to mount other electronic components in a space between the upper and lower PCBs on which the filter is seated.

### DETAILED DESCRIPTION OF THE INVENTION

### Technical Problem

Accordingly, the present disclosure is directed to solving the above-described problems, and a primary object thereof is to provide a filter for a communication device having reduced volume and weight.

In addition, the main purpose of the present disclosure is to provide a filter for a communication device capable of reducing insertion loss caused by coupling of a plurality of physical structures by minimizing conventional joining processes for forming a cavity and providing structures such as resonators within the cavity.

In addition, the main purpose of the present disclosure is to provide a filter for a communication device capable of preventing loss of the filter and improving reliability of a product by reinforcing rigidity in product assembly of a filter provided by a folding method of a thin main plate having relatively low rigidity, in which PCBs (printed circuit boards) are seated on upper and lower portions of the filter.

The problems to be solved by the present disclosure are not limited to the problems mentioned above, and other problems not mentioned will be clearly understood by those skilled in the art from the following description.

### Technical Solution

According to an embodiment of the present disclosure for achieving the above-described objects, there is provided a filter for a communication device, comprising: a filter housing including a cavity for performing frequency filtering; and at least one connector configured to input an electrical signal into the cavity or to output an electrical signal input to the cavity to an outside of the cavity, wherein the filter housing is formed by folding at least a portion of a main plate configured as a conductive plate.

### Effects of the Invention

As described above, according to the present embodiment, it is possible to provide a filter for a communication device having reduced volume and weight.

In addition, there is an effect of providing a filter for a communication device capable of reducing insertion loss caused by coupling of a plurality of physical structures by minimizing conventional joining processes for forming a cavity and providing structures such as resonators within the cavity.

Further, there is an effect of providing a filter for a communication device capable of preventing loss of the filter and improving reliability of a product by reinforcing rigidity in product assembly of a filter provided by a folding method of a thin main plate having relatively low rigidity, in which PCBs (printed circuit boards) are seated on upper and lower portions of the filter.

### BRIEF DESCRIPTION OF THE DRAWINGS

FIG. 1 is a perspective view of a filter for a communication device according to a first embodiment of the present disclosure.

FIG. 2 is a developed view of a filter housing according to the first embodiment of the present disclosure.

FIG. 3 is a left side sectional view of a filter for a communication device according to the first embodiment of the present disclosure.

FIG. 4 is a front sectional view of a filter for a communication device according to the first embodiment of the present disclosure.

FIG. 5 is a rear sectional view of a filter for a communication device according to the first embodiment of the present disclosure.

FIG. 6 is a view illustrating an arrangement state of a resonator panel and a frequency tuning panel according to the first embodiment of the present disclosure.

FIG. 7 is an upward perspective view of a connector according to the first embodiment of the present disclosure.

FIG. 8 is a perspective view of a filter for a communication device according to a second embodiment of the present disclosure.

FIG. 9 is a developed view of a filter housing according to the second embodiment of the present disclosure.

FIG. 10 is a downward perspective view of a connector according to the second embodiment of the present disclosure.

### DETAILED DESCRIPTION OF THE INVENTION

Hereinafter, some embodiments of the present disclosure will be described in detail using exemplary drawings. In assigning reference numerals to the components of each drawing, it should be noted that the same components are given the same numerals as much as possible even if they are shown in different drawings. Furthermore, in describing the present disclosure, when it is determined that a detailed description of a related known configuration or function may obscure the gist of the present disclosure, the detailed description thereof will be omitted.

In describing the components of the embodiment according to the present disclosure, symbols such as first, second, i), ii), a), b), etc. may be used. These symbols are solely for distinguishing the component from other components, and the nature, sequence, or order of the component is not limited by the symbol.

When a component is described as being ‘connected’, ‘coupled’, or ‘attached’ to another component, it should be understood that the component may be directly connected or attached to the other component, but another component may also be ‘connected’, ‘coupled’, or ‘attached’ between the respective components.

When a part of the specification is said to “include” or “comprise” a component, this means that it may further include other components rather than excluding other components, unless expressly stated to the contrary.

Hereinafter, in order to describe the shape of a filter for communication equipment according to the present disclosure, the terms length, width, and height of the filter for communication equipment may be used. The length means a horizontal length based on a front view, the width means a horizontal length based on a right side view, and the height means a vertical length based on the front view.

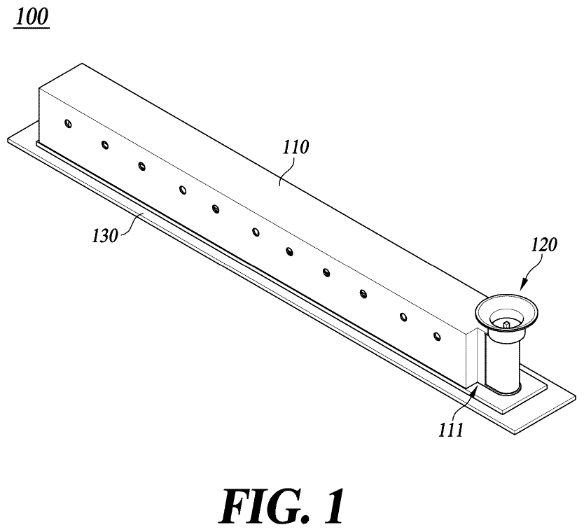

FIG. 1 is a perspective view of a filter for a communication device according to a first embodiment of the present disclosure.

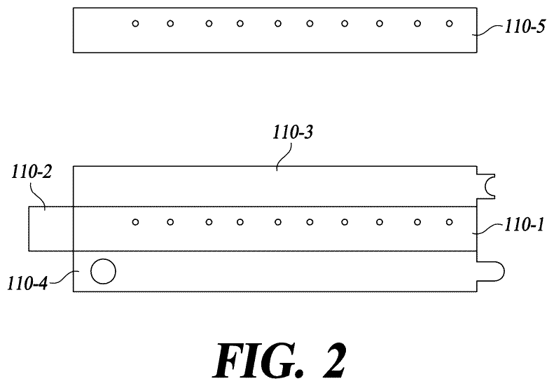

FIG. 2 is a developed view of a filter housing according to the first embodiment of the present disclosure.

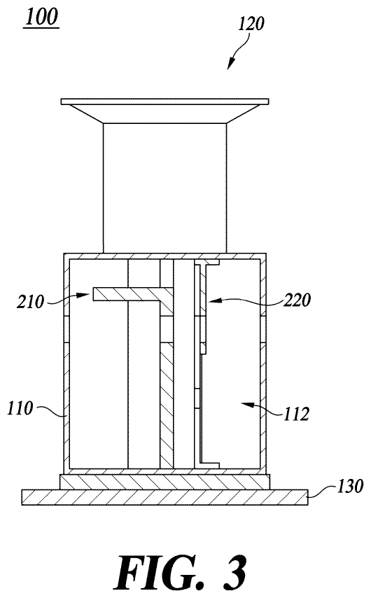

FIG. 3 is a left side sectional view of a filter for a communication device according to the first embodiment of the present disclosure.

Referring to FIGS. 1 to 3, a filter for a communication device (100) according to a first embodiment of the present disclosure may include all or some of a filter housing (110), at least one connector (120), a resonator panel (210), and a frequency tuning panel (220).

The filter housing (110) may include a cavity (112). The cavity (112) refers to an empty space inside the filter housing (110). The cavity (112) may induce propagation of an electrical signal. The cavity (112) may be provided to perform frequency filtering using resonance. That is, a frequency of an electrical signal introduced into the cavity (112) may be filtered by a resonance effect.

The filter housing (110) may be manufactured using a conductive plate. For example, the filter housing (110) may be manufactured using a material such as aluminum, copper, stainless steel, titanium, or nickel. As the filter housing (110) is manufactured using a conductive plate, it is possible to prevent an electrical signal input into the filter housing (110) from leaking to an outside of the filter housing (110). In addition, the filter housing (110) manufactured using such materials has effects of excellent durability and strong corrosion resistance.

The filter housing (110) may be disposed between a plurality of boards. Here, the plurality of boards may refer to a PCB (printed circuit board, 130) or an antenna board (not shown) including at least one radiating element on a front surface thereof. Accordingly, the filter for the communication device (100) may transmit and receive a filtered signal between the plurality of boards by using the connector (120).

The filter housing (110) may include an opening part (111) on an other side of the cavity (112). The opening part (111) collectively refers to an opened portion of the filter housing (110) and a portion of the filter housing (110) located at the opened portion. Here, the other side of the cavity refers to a right side based on a front view. The opening part (111) may be configured to form a step difference with respect to the filter for the communication device (100) according to the first embodiment of the present disclosure. For example, when the filter housing (110) is viewed in a right side view, a height of the opening part (111) and a height of the filter housing (110) may be the same, while a width of the opening part (111) may be smaller than a width of the filter housing (110). The width of the opening part (111) may be the same as a width or a diameter of a supporting part (121). The opening part (111) may be blocked by integrally coupling the filter housing (110) and the connector (120). A detailed description of a method and a shape in which the filter housing (110) is integrally coupled with the connector (120) will be described later with reference to FIG. 7.

The filter housing (110) may be formed by folding at least a portion of main plates (110-1 to 110-4), which are conductive plates, and integrally coupling a cover plate (110-5).

The main plate (110-1 to 110-4) may include a front-forming panel (110-1), a bottom-forming panel (110-4), a top-forming panel (110-3), and a one-end forming panel (110-2).

The front-forming panel (110-1) may form a front portion of the filter housing.

The one-end forming panel (110-2) may be folded from one side of the front-forming panel (110-1) to form one end surface of the filter housing (110).

The bottom-forming panel (110-4) and the top-forming panel (110-3) may be folded from a lower side and an upper side of the front-forming panel (110-1) in the same direction, respectively, to form a bottom surface and a top surface of the filter housing (110).

The filter housing (110) and the connector (120) may be integrally coupled through the following processes.

The main plates (110-1 to 110-4) are folded. Respective edges of the main plates (110-1 to 110-4) that are in mutual contact are integrally coupled to configure a three-dimensional shape. The main plates (110-1 to 110-4) and the connector (120) are integrally coupled. Edges of the cover plate (110-5) are integrally coupled to the edges of the main plates (110-1 to 110-4). The connector (120) and the cover plate (110-5) are integrally coupled. In the present disclosure, the filter for the communication device (100) is described as having a rectangular parallelepiped shape; however, the shape of the filter for the communication device (100) is not limited thereto. For example, the filter for the communication device (100) may have a triangular prism shape or a pentagonal prism shape, and in this case, a shape of the main plate and/or a folding method thereof may be different from those described above.

As can be seen in FIG. 2, the top-forming panel (110-3) and the bottom-forming panel (110-4) may be configured in shapes for being integrally coupled with the connector (120).

As another example different from the first embodiment, the main plates (110-1 to 110-4) may not include the one-end forming panel (110-2), the filter housing (110) may include a plurality of opening parts, and the connector (120) may be integrally coupled with the filter housing (110) so as to close the plurality of opening parts.

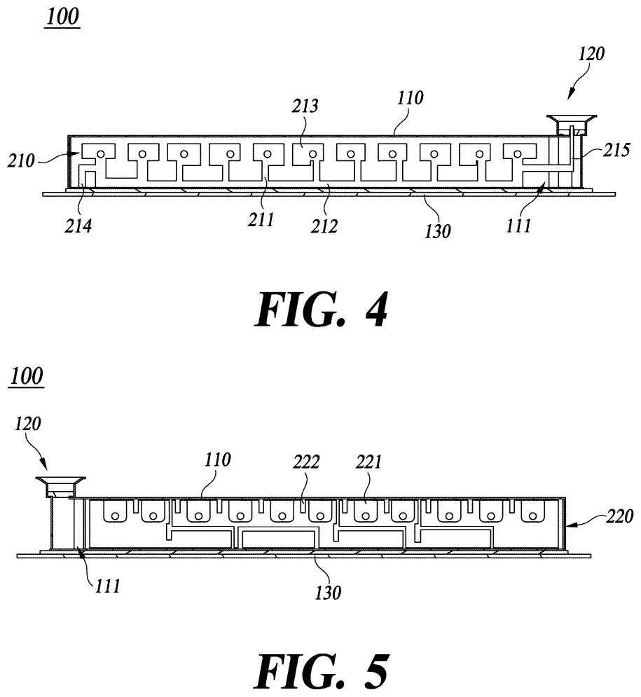

FIG. 4 is a front sectional view of a filter for a communication device according to the first embodiment of the present disclosure.

FIG. 5 is a rear sectional view of a filter for a communication device according to the first embodiment of the present disclosure.

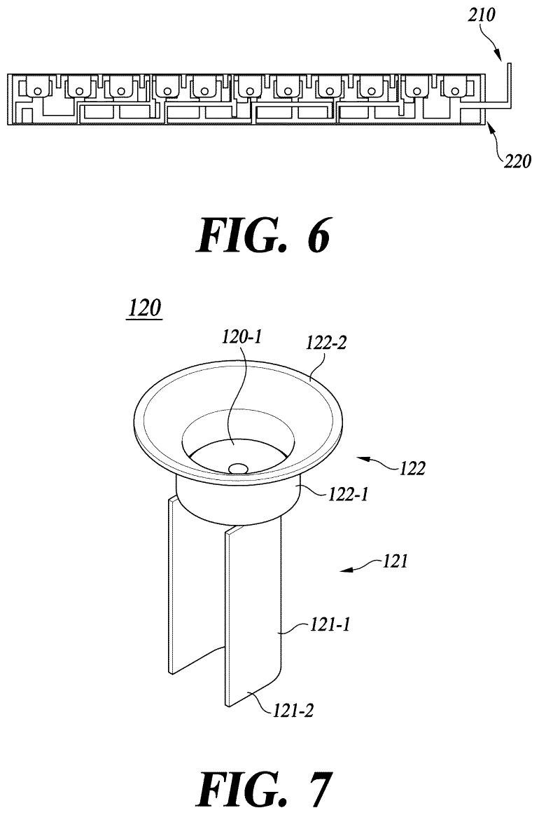

FIG. 6 is a view illustrating an arrangement state of a resonator panel and a frequency tuning panel according to the first embodiment of the present disclosure.

Referring to FIGS. 1 to 6, the resonator panel (210) and the frequency tuning panel (220) of a filter for the communication device (100) according to a first embodiment of the present disclosure will be described in detail.

The resonator panel (210) may be disposed within the cavity (112) to filter a frequency of an electrical signal. The resonator panel (210) may be connected to the connector (120) to receive an electrical signal from the connector, filter a frequency of the electrical signal, and then transmit the frequency-filtered electrical signal to the connector (120). In order for the resonator panel (210) to generate a resonance effect to filter the frequency of the electrical signal, the resonator panel (210) may include all or some of a plurality of resonators (211), a resonator connect bar (212), and a plurality of resonant characteristic sections (213).

The plurality of resonators (211) may be configured to form a single layer from inside the cavity (112). For example, when the filter for the communication device (100) according to the first embodiment of the present disclosure is viewed based on a view of FIG. 3, the plurality of resonators (211) may appear to overlap with each other. The plurality of resonators (211) may be arranged horizontally in a longitudinal direction of the filter for the communication device (100) according to the first embodiment of the present disclosure to form the single layer.

The resonator connect bar (212) may horizontally connect the plurality of resonators (211) in a longitudinal direction of the cavity (112). The resonator connect bar (212) may include an input section (214) for being connected to the PCB (130) from one side of the cavity (112), and an output section (215) for being connected to the connector (120) from the other side of the cavity (112). The resonator connect bar (212) may perform a role of an electrical wire that receives an electrical signal from the input section (214) and transmits the electrical signal to each resonator (211). The electrical signal input to the input section (214) may reach each resonator (211) using the resonator connect bar (212) to be filtered, and then may be delivered to outside of the cavity (112) using the output section (215).

The resonant characteristic section (213) may be formed to extend from a leading end of each of the plurality of resonators (211). The resonant characteristic section (213) may overlap with a tuning bar (221) to perform a role of adjusting a resonance frequency. That is, a plurality of inductors and capacitors may be formed by using shapes and arrangements of the resonant characteristic section (213) and the tuning bar (221).

The frequency tuning panel (220) may be disposed within the cavity (112) to adjust a frequency characteristic of the filter for the communication device (100) according to the first embodiment of the present disclosure. The frequency tuning panel (220) may be configured in a rectangular shape having a hollow interior. In order for the frequency tuning panel (220) to adjust the frequency characteristic, the frequency tuning panel (220) may include a plurality of tuning bars (221) and at least one coupling control bar (222).

The plurality of tuning bars (221) may be configured to form a single layer (single layer) from inside the cavity (112). For example, when the filter for the communication device (100) according to the first embodiment of the present disclosure is viewed based on a view of FIG. 3, the plurality of tuning bars (221) may appear to overlap with each other. The plurality of tuning bars (221) may be arranged horizontally in a longitudinal direction of the filter for the communication device (100) according to the first embodiment of the present disclosure to form the single layer. Each of the plurality of tuning bars (221) may be formed to extend from an inner end of the frequency tuning panel (220) toward an opposite end.

The coupling control bar (222) may be formed to extend from an inner end of the frequency tuning panel (220) toward an opposite end. The coupling control bar (222) may be disposed between adjacent tuning bars (221) among the plurality of tuning bars (221) so as to be configured to form the same single layer as the plurality of tuning bars (221).

The resonator panel (210) and the frequency tuning panel (220) may be disposed to be spaced apart from each other from inside the cavity (112). Each resonator (211) of the resonator panel (210) and each tuning bar (221) of the frequency tuning panel (220) may be disposed to overlap with each other. For example, as can be seen in FIG. 6, when the filter for the communication device (100) according to the first embodiment of the present disclosure is viewed from a front side or a rear side thereof, each resonator (211) of the resonator panel (210) and each tuning bar (221) of the frequency tuning panel (220) may overlap with each other.

FIG. 7 is an upward perspective view of a connector according to the first embodiment of the present disclosure.

Referring to FIGS. 1 to 7, a connector (120) according to a first embodiment of the present disclosure will be described in detail.

The connector may be configured to receive an electrical signal from the PCB (130) and input the electrical signal to one side of the cavity (112) or to output the electrical signal from the other side of the cavity (112). Here, the one side of the cavity (112) refers to a side opposite to the other side of the cavity (112) described above, and in the present disclosure, is described as a left side based on a front view. In order to receive the electrical signal from the PCB (130) and input the electrical signal to the cavity (112), the connector may be provided as a configuration separate from the resonator panel (210). Alternatively, the connector may be configured as a part of the resonator panel (210) in a form of the input section (214) or output section (215). In this case, the connector may be coupled to a front surface of the PCB (130) using an SMT (Surface Mount Technology) method.

The connector (120) may be configured as a hollow type such that the output section (215) penetrates through the connector (120) in a height direction of the cavity (112). A height of the connector (120) may be configured to have a value greater than a height of the filter housing (110). The connector (120) may be configured using a material having higher rigidity than the main plates (110-1 to 110-4). As the connector (120) has a height greater than the height of the filter housing (110) and has higher rigidity than the main plates (110-1 to 110-4), it is possible to protect the filter for the communication device (100) and reduce insertion loss when coupling the filter for the communication device (100) with a plurality of boards. For example, when the plurality of boards and the filter for the communication device (100) are connected using the connector (120), a predetermined space may be generated between the plurality of boards and the filter for the communication device (100) due to the height of the connector (120). Due to the presence of the predetermined space, contact between the filter housing (110) and the plurality of boards may be prevented, and accordingly, damage to the filter housing (110) and insertion loss may be reduced. In addition, since a weight of a board coupled at an upper side of the filter is supported by the connector rather than the filter, and the weight is received toward a lower end of the connector (that is, a lower end portion of the connector penetrating the filter and seated on a lower board portion), the weight of the board portion does not directly affect the filter, thereby making it possible to prevent damage to the filter and signal loss.

The connector (120) may be manufactured by forming a metal plate using a deep drawing process and then applying a cutting process. The deep drawing process refers to press machining for generating a hollow-type container by applying pressure to a punch and a die having a deep shape in a vertical direction at a central portion of a flat plate.

When the connector (120) is manufactured using the deep drawing process and the cutting process, a manufacturing process may be as follows.

A metal plate is placed on a die of a deep drawing press. A punch of the deep drawing press is operated to repeatedly press the metal plate. When the punch presses the metal plate, the metal plate is deformed along a shape of the die. A shape of the metal is completed by using a cutting process such as laser cutting, needle cutting, or punch cutting.

As the connector (120) is manufactured using the deep drawing process and the cutting process, it is possible to minimize loss of a material constituting the connector (120) during a manufacturing process of the connector (120).

The connector (120) may include the supporting part (121) and a radial part (122).

The supporting part (121) may be formed to vertically extend from a lower portion of an inner surface of the filter housing (110) toward a top surface direction of the filter housing (110). The supporting part (121) may be configured to be integrally coupled with the filter housing (110) to block the opening part (111). Accordingly, a height of the supporting part (121) may be equal to or greater than a height of the filter for a communication device (100) according to the first embodiment of the present disclosure.

The supporting part (121) may include a first support body (121-1) and a second support body (121-2). When at least one board among the plurality of boards is coupled to the connector (120) and normal stress is generated on the connector (120) toward the PCB (130) direction, the first support body (121-1) may perform a role of supporting stiffness of the connector (120). The first support body (121-1) may be opened toward a direction in which the cavity (112) is located. As a portion of the first support body (121-1) is opened, the cavity (112) and the connector (120) may form a space. The second support body (121-2) may extend from an open end of the first support body (121-1) in a longitudinal direction of the cavity (112). Based on a front view, the second support body (121-2) may overlap with at least a portion of the opening part (111) to be integrally coupled thereto. The second support body (121-2) may be integrally coupled with at least a portion of the filter housing (110) by using a welding process or a brazing process.

The radial part (122) may be configured to extend from one end portion of the supporting part (121) and protrude toward a rear surface direction of an antenna board. The radial part (122) may support a rear surface of the antenna board. The radial part (122) may perform a role of grounding the filter housing (110). The radial part (122) may include a first portion (122-1) and a second portion (122-2).

The first portion (122-1) may be formed to directly extend from one end portion of the supporting part (121). The first portion (122-1) may perform a role of a support for forming the second portion (122-2). A dielectric (120-1) may be inserted into the first portion (122-1). The dielectric (120-1) functions to reinforce strength of the connector (120), prevent introduction of foreign substances into the cavity (112), and prevent loss of an electrical signal input into the cavity (112). The dielectric (120-1) may be configured of a material such as Teflon, Poly-Propylene, Poly-Amide, Poly-Styrene, Poly-Carbonate, Poly-Phenylenesulfide, Poly-Vinyl-Fluoride, or Poly-Tetra-Fluoro-Ethylene.

The second portion (122-2) may be radially formed from the first portion (122-1) in a direction opposite to the supporting part (121). For example, a planar cross-section of the second portion (122-2) may have an area that increases as the planar cross-section becomes farther from the first portion (122-1). When a board and the filter for a communication device (100) are connected, the filter for a communication device (100) according to the present disclosure has an effect of increasing a connection width by using the radial part (122) in order to prevent irregular disconnection with the board due to vibration and the like.

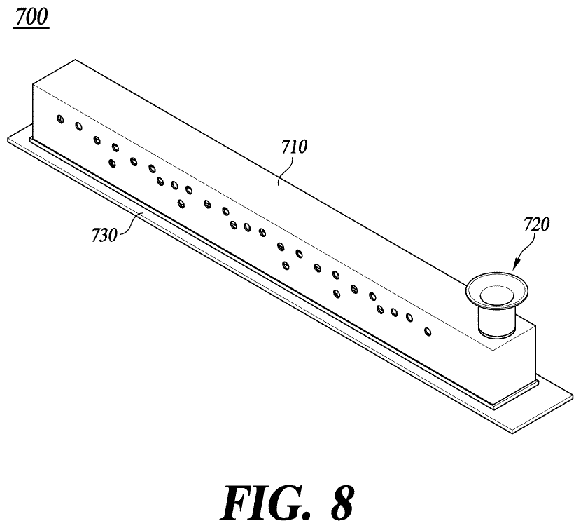

FIG. 8 is a perspective view of a filter for a communication device according to a second embodiment of the present disclosure.

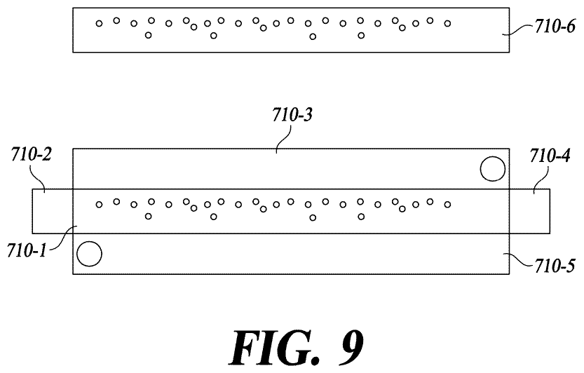

FIG. 9 is a developed view of a filter housing according to the second embodiment of the present disclosure.

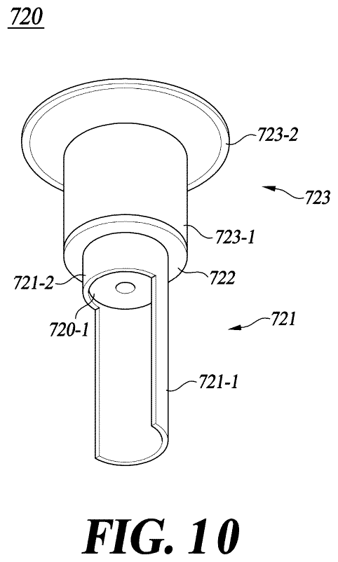

FIG. 10 is a downward perspective view of a connector according to the second embodiment of the present disclosure.

Referring to FIGS. 8 to 10, a filter for a communication device (700) according to a second embodiment of the present disclosure may include all or some of a filter housing (710), at least one connector (720), a resonator panel (not shown), and a frequency tuning panel (not shown).

Components according to the second embodiment of the present disclosure may be the same as components according to the first embodiment, except for components specifically described below, and thus detailed descriptions of the same parts will be omitted.

The filter housing (710) according to the second embodiment of the present disclosure does not include an opening part (111). The at least a portion of the connector (720) is inserted through the filter housing (710) according to the second embodiment of the present disclosure and integrally coupled with the filter housing (710).

Accordingly, the main plate (710-1 to 710-5) according to the second embodiment of the present disclosure may further include a right-end forming panel (710-4), unlike the main plate (110-1 to 110-4) according to the first embodiment. The right-end forming panel (710-4) may be folded from the front-forming panel (710-1) in the same direction as the left-end forming panel (710-2) to form a right end surface of the filter housing (710).

At least one of the front-forming panel (710-1), the left-end forming panel (710-2), the right-end forming panel (710-4), the bottom-forming panel (710-5), the top-forming panel (710-3), and the cover plate (710-6) may include a hole through which the at least one connector (720) passes.

The at least one connector (720) may be coupled and installed to the filter housing (710) by penetrating the hole and the cavity (712).

The connector (720) may include a supporting part (721), a connecting washer part (722), and a radial part (723).

The supporting part (721) may include a first support body (721-1) and a second support body (721-2), as in the first embodiment of the present disclosure. However, unlike the first embodiment of the present disclosure, the second support body (721-2) may be configured to block an open end formed by the first support body (721-1) from an upper end portion of the first support body. The reason why the second support body (721-2) blocks at least a portion of the open end of the first support body (721-1) is to reinforce rigidity of the connector (720) and to reduce an amount of material lost by a cutting process. A lower end of the first support body (721-1) may be integrally coupled with a bottom surface.

The connecting washer part (722) may be formed to extend from a lower end portion of the radial part (723). The connecting washer part (722) may be integrally coupled with an upper surface or a lower surface of the filter housing (710). The connecting washer part (722) may be integrally coupled with the filter housing (710) using the welding process or the brazing process.

When respective components of a filter for a communication device are assembled, a connector and a filter housing may not be integrally coupled with each other. When the connector and the filter housing are not integrally coupled with each other, irregular disconnection between the filter housing and the connector may occur. The irregular disconnection between the filter housing and the connector may cause damage to the filter housing and may cause loss of an electrical signal input into a cavity. The filter for the communication device (100, 700) according to the present disclosure has an effect of preventing occurrence of irregular disconnection between the connector (120, 720) and the filter housing (110, 710) by integrally coupling the connector (120, 720) and the filter housing (110, 710).

The filter for the communication device (100, 700) according to the present disclosure has an effect of reducing manufacturing cost by minimizing a manufacturing process of the filter for the communication device (100, 700) by being manufactured in a manner of folding the main plate (110-1 to 110-4, 710-1 to 710-5).

The above description is merely illustrative of the technical concept of the present embodiment, and those skilled in the art to which the present embodiment pertains will be able to make various modifications and variations without departing from the essential characteristics of the present embodiment. Therefore, the present embodiments are intended to illustrate rather than limit the technical concept of the present embodiment, and the scope of the technical concept of the present embodiment is not limited by these embodiments. The scope of protection of the present embodiment should be construed according to the following claims, and all technical concepts within an equivalent scope should be construed as being included in the scope of rights of the present embodiment.

### DESCRIPTION OF REFERENCE NUMERALS

100: filter for a communication device 110: filter housing
111: opening part 112: cavity
120: connector according to a first embodiment 130: PCB
210: resonator panel 220: frequency tuning panel

1. A communication device filter, comprising:
a filter housing including a cavity for performing frequency filtering; and
at least one connector configured to input an electrical signal into the cavity or to output an electrical signal input to the cavity to an outside of the cavity, and disposed integrally with the filter housing,
wherein the filter housing is
formed by folding at least a portion of a main plate configured as a conductive plate.

2. The communication device filter according to claim 1, wherein
the main plate comprises:
a front-forming panel forming a front surface of the filter housing;
a one-end forming panel folded from one side of the front-forming panel to form one end surface of the filter housing; and
a bottom-forming panel and a top-forming panel folded from lower and upper sides of the front-forming panel in the same direction to respectively form a bottom surface and a top surface of the filter housing.

3. The communication device filter according to claim 2, further comprising
a cover plate forming a rear surface of the filter housing,
wherein the cavity is
formed by folding the main plate and then integrally coupling the cover plate to the folded main plate.

4. The filter for a communication device according to claim 3, wherein
the filter housing comprises an opening part opening the other side of the cavity, and
the other side of the cavity is closed by integrally coupling the at least one connector to the filter housing.

5. The filter for a communication device according to claim 1, wherein
the main plate comprises:
a front-forming panel forming a front surface of the filter housing;
a left-end forming panel and a right-end forming panel folded from left and right sides of the front-forming panel in the same direction to respectively form a left end surface and a right end surface of the filter housing; and
a bottom-forming panel and a top-forming panel folded from lower and upper sides of the front-forming panel in the same direction to respectively form a bottom surface and a top surface of the filter housing.

6. The filter for a communication device according to claim 5, further comprising:
a cover plate forming a rear surface of the filter housing,
wherein the cavity is:
formed by folding the main plate and then integrally coupling the cover plate to the folded main plate.

7. The filter for a communication device according to claim 6, wherein
at least one of the front-forming panel, the left-end forming panel, the right-end forming panel, the bottom-forming panel, the top-forming panel, and the cover plate comprises a hole through which the at least one connector penetrates, and
the at least one connector is coupled and installed to the filter housing by penetrating the hole and the cavity.

8. The filter for a communication device according to claim 1, wherein
the at least one connector is coupled to the filter housing by using at least one of a brazing process and a welding process.

9. The filter for a communication device according to claim 1, wherein
a height of the at least one connector is greater than a height of the filter housing.

10. The filter for a communication device according to claim 1, wherein
the at least one connector is made of a material having higher rigidity than the main plate.

11. The filter for a communication device according to claim 1, wherein
the connector is manufactured by forming a metal plate by a deep drawing process and then cutting the metal plate.

12. The filter for a communication device according to claim 1, further comprising:
a resonator panel including a plurality of resonators connected to the at least one connector and disposed within the cavity in a longitudinal direction of the cavity; and
a frequency tuning panel including a plurality of tuning bars disposed within the cavity in the longitudinal direction of the cavity.

13. The filter for a communication device according to claim 12, wherein
the resonator panel further comprises:
a resonator connecting bar for connecting the plurality of resonators in a longitudinal direction of the cavity; and
a plurality of resonant characteristic sections extending from respective leading ends of the plurality of resonators.

14. The filter for a communication device according to claim 12, wherein
the frequency tuning panel is disposed within the cavity and spaced apart from the resonator panel.

15. The filter for a communication device according to claim 12, wherein
the frequency tuning panel is configured as a rectangular hollow frame, and
each of the plurality of tuning bars extends from an inner end of the frequency tuning panel toward an opposite end.

16. The filter for a communication device according to claim 12, wherein
the resonator panel and the frequency tuning panel are disposed such that each of the plurality of tuning bars overlaps with a corresponding one of the plurality of resonators in a width direction of the filter housing.

17. The filter for a communication device according to claim 12, wherein
the frequency tuning panel further comprises:
at least one coupling control bar extending from an inner end of the frequency tuning panel toward an opposite end and disposed between adjacent tuning bars among the plurality of tuning bars so as to form a single layer together with the plurality of tuning bars.

18. The filter for a communication device according to claim 12, wherein
the resonator panel and the frequency tuning panel are coupled to the filter housing by at least one of a brazing process and a welding process.
